(19) United States
(12) Patent Application Publication
(10) Pub. No.: US 2005/0217361 A1
(43) Pub. Date: Oct. 6, 2005

(54) Tire pressure measurement device capable of automatically generating electric power

(76) Inventor: Wen Hsiang Yueh, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/814,150

(22) Filed: Apr. 1, 2004

(51) Int. Cl. G01M 17/02

(52) U.S. Cl. 73/146

(57) ABSTRACT

A tire pressure measurement device capable of automatically generating electric power has a tire pressure measurement unit, a microprocessor control unit and an automatic generating unit. One or more permanent magnets are disposed in the automatic generating unit and annularly arranged on a braking panel. An induction coil is disposed at a corresponding portion of the magnetic permanent. The induction coil is formed by continually winding a conducting wire around an aluminum ring. Each distal end of the induction coil is connected with an electric power lead-out wire. An electric power can thus be generated and led to the microprocessor control unit and the tire pressure measurement unit when a vehicle's wheel rotates.

### FIELD OF THE INVENTION

The present invention relates to a tire pressure measurement device capable of automatically generating electric power and, more particularly, to a device, which can automatically generate electric power and conduct the electric power out to subassemblies in the tire room when a vehicle's wheel rotates.

### BACKGROUND OF THE INVENTION

Generally, as shown in FIG. 1, the working electric power of a tire pressure measurement unit 60 used for measuring the tire pressure of a tested tire (including abnormal signals such as a too high tire pressure, a too low tire pressure and an insufficient electric power) is directly provided by the voltage generated by a power source regulating circuit 65.

An electric current can be generated through the interaction between a permanent magnet disposed in a wheel body of a skateboard, an inline skate or a roller skate and a coil for inducing a current to let light emitting devices installed on the wheel body emit light.

Therefore, if a device can be provided to generate automatically electric power provided to the above tire pressure measurement unit, the problem of an insufficient electric power can be solved.

### SUMMARY OF THE INVENTION

One object of the present invention is to provide a device capable of automatically generating electric power and conducting this electric power out for providing working power for subassemblies like a thermometer, a gradienter, and a tire pressure measurement unit in the tire room when a vehicle's wheel rotates.

To achieve the above object, a tire pressure measurement device capable of automatically generating electric power of the present invention comprises a tire pressure measurement unit, a microprocessor control unit and an automatic generating unit. One or more permanent magnets are disposed in the automatic generating unit and annularly arranged on a braking panel. An induction coil is disposed in a corresponding portion of the magnetic permanent. The induction coil is formed by continually winding a conducting wire around an aluminum ring. Each distal end of the induction coil is connected with an electric power lead-out wire. An electric power can thus be generated and conducted to the microprocessor control unit and the tire pressure measurement unit when a vehicle's wheel rotates. The above microprocessor control unit is connected with a thermometer for measuring the temperature of the tire and a gradienter for measuring the balance state of the tire. The thermometer and the gradienter are connected to the electric power lead-out wires of the induction coil.

### BRIEF DESCRIPTION OF THE DRAWINGS

The various objects and advantages of the present invention will be more readily understood from the following detailed description when read in conjunction with the appended drawings, in which:

FIG. 1 is an architectural diagram of a conventional tire pressure measurement unit;

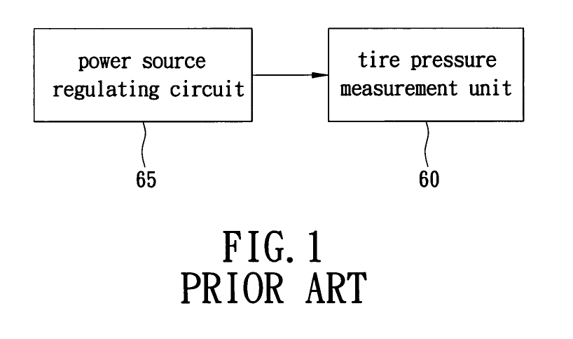

FIG. 2 is an architectural diagram of the present invention; and

FIG. 3 is a structural diagram of an automatic generating unit of the present invention.

### DETAILED DESCRIPTION OF THE PREFERRED EMBODIMENTS

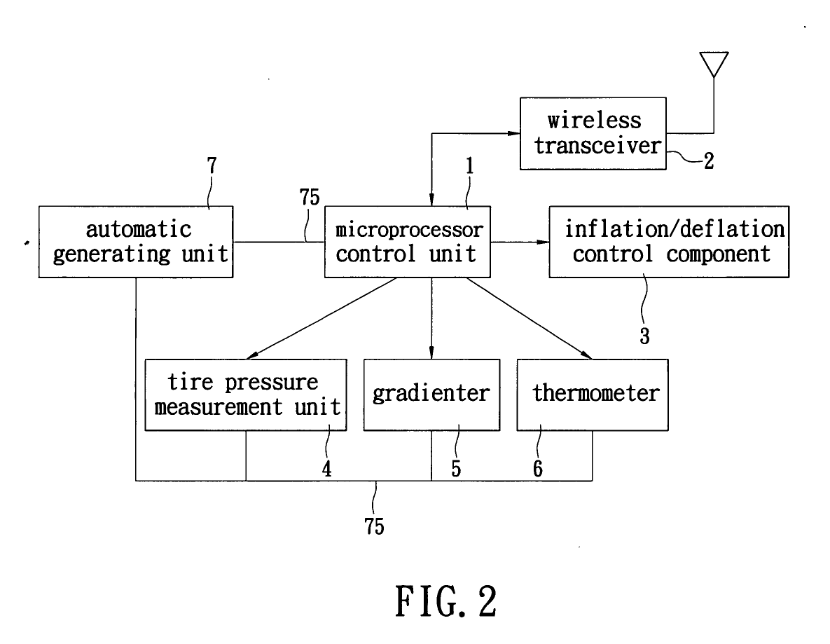

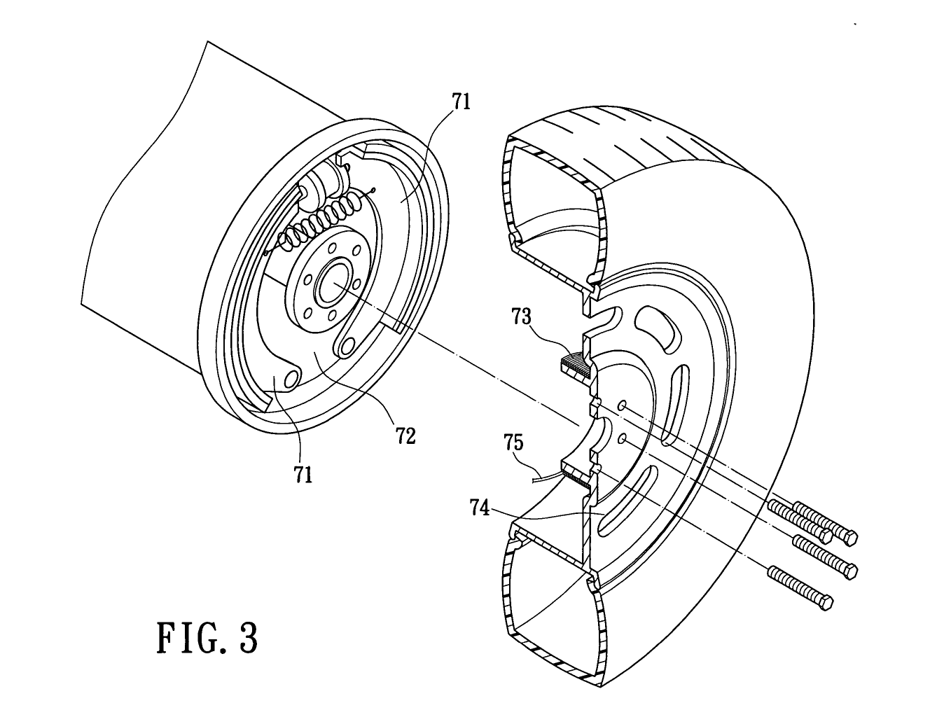

As shown in FIGS. 2 and 3, a tire pressure measurement device capable of automatically generating electric power of the present invention is a device for measuring a tire pressure value of a tested tire and sending out this tire pressure value in a wireless way. The tire pressure measurement device comprises a microprocessor control unit 1, a wireless transceiver 2, an inflation/deflation control component 3, a tire pressure measurement unit 4 and an automatic generating unit 7.

The tire pressure measurement unit 4 is disposed in a tire room and used for measuring a tire pressure of a tested tire to detect abnormal signals like a too high tire pressure, a too low tire pressure or an insufficient electric power and the tire pressure state.

The microprocessor control unit 1 is connected with a wireless transceiver 2, an inflation/deflation control component 3 and a tire pressure measurement unit 4. The microprocessor control unit 1 processes the signal data measured by the tire pressure measurement unit 4 and sends the signal data via the wireless transceiver 2 in a wireless way or receives signals from the wireless transceiver 2, thereby operating the inflation/deflation control component 3.

The automatic generating unit 7 has one or more permanent magnets 71 annularly arranged on a braking panel 72. An induction coil 73 is disposed a corresponding portion of the permanent magnet 71. The induction coil 73 is formed by continually winding a conducting wire around an aluminum ring 74. Each distal end of the induction coil 73 is connected to an electric power lead-out wire 75. The induction coil 73 can generate an induced electromotive force to provide power for the microprocessor control unit 1 and the tire pressure measurement unit 4 through rotation of the wheel.

Reference is again made to FIG. 2. A gradienter 5 for measuring the balance state of the tire and a thermometer 6 for measuring the temperature of the tire can be provided in the tire room. The gradienter 5 and the thermometer 6 are connected to the electric power lead-out wires 75 of the induction coil 73, and are also connected to the microprocessor control unit 1.

When the wheel rotates, the induction coil 73 generates an induced electromotive force to provide power for the microprocessor control unit 1, the tire pressure measurement unit 4, the gradienter 5 and the thermometer 6 via the electric power lead-out wires 75.

To sum up, the present invention can generate an electric power when a vehicle's wheel rotates and conducts this electric power to the microprocessor control unit, the tire pressure measurement unit, the thermometer and the gradienter.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A tire pressure measurement device capable of automatically generating electric power for measuring a tire pressure value of a tested tire and wirelessly sending out said tire pressure value, said tire pressure measurement device comprising
a microprocessor control unit connected with a tire pressure measurement unit; and
a wireless transceiver and an inflation/deflation control component, said microprocessor control unit processing signal data obtained by said tire pressure measurement unit and wirelessly sending out said signal data via said wireless transceiver, or receiving signals from said wireless transceiver, thereby operating said inflation/deflation control component;
whereby working electric power of said microprocessor control unit comes from an automatic generating unit having one or more permanent magnets annularly arranged on a braking panel, and wherein an induction coil is disposed on a corresponding portion of said permanent magnet, said induction coil is formed by continually winding a conducting wire around an aluminum ring, each distal end of said induction coil is connected to an electric power lead-out wire, and said induction coil can generate an induced electromotive force through rotation of said wheel and provide power for said microprocessor control unit.

2. The tire pressure measurement device capable of automatically generating electric power as claimed in claim 1, wherein a thermometer for measuring a temperature of said tire is disposed in said tire room, and said thermometer is connected with said electric power lead-out wires of said induction coil and said microprocessor control unit.

3. The tire pressure measurement device capable of automatically generating electric power as claimed in claim 1, wherein a gradienter for measuring a balance status of said tire is disposed in said tire room, and said gradienter is connected with said electric power lead-out wires of said induction coil and said microprocessor control unit.
